(19) United States
(12) Patent Application Publication
(10) Pub. No.: US 2012/0221785 A1
(43) Pub. Date: Aug. 30, 2012

(54) Polymorphic Stacked DRAM Memory Architecture

(76) Inventors: Jaewoong Chung, Bellevue, WA (US); Niranjan Soundararajan, Hillsboro, OR (US)

(21) Appl. No.: 13/036,839

(22) Filed: Feb. 28, 2011

(51) Int. Cl. G06F 12/06; G06F 12/08

(52) U.S. Cl. 711/105; 711/132; 711/E12.02; 711/E12.078

(57) ABSTRACT

A 3D stacked processor device is described which includes a processor chip and a stacked polymorphic DRAM memory chip connected to the processor chip through a plurality of through-silicon-via structures, where the stacked DRAM memory chip includes a memory with an adjustable memory portion and an adjustable cache portion such that memory can operate simultaneously in both memory and cache modes.

### BACKGROUND OF THE INVENTION

1. Field of the Invention

The present invention relates in general to integrated circuits. In one aspect, the present invention relates to a dynamic random access memory (DRAM) architecture and method for operating same.

2. Description of the Related Art

With today's high performance multi-core devices, there can be significant performance limitations created when multiple cores request read/write access to off-chip DRAM memory over limited bandwidth I/O pins which have limited scalability. Off-chip DRAM memory is also limited by the lack of scalability in the DIMM slots per channel. Data bandwidth can be improved with multi-dimensional stacking of memory on the processing element(s) which also reduces access latency, reduces energy and power requirements, and enables merging of different technologies (e.g., static random access memory and DRAM) on top of processing logic to increase storage sizes. However, the addition of a large storage memory area in the stacked memory presents storage management challenges for efficiently using the additional memory and preventing performance losses or costs associated with stacked memories, depending on whether the stacked memories operate as memories or caches. In addition, designers have conventionally used stacked DRAM as either a large fast last-level cache or as memory in which an entire application's footprint gets mapped into it and their data are available quickly.

Accordingly, a need exists for an improved architecture, circuit, method of operation, and system for stacking memories on a processing element which addresses various problems in the art that have been discovered by the above-named inventors where various limitations and disadvantages of conventional solutions and technologies will become apparent to one of skill in the art after reviewing the remainder of the present application with reference to the drawings and detailed description which follow, though it should be understood that this description of the related art section is not intended to serve as an admission that the described subject matter is prior art.

### SUMMARY OF EMBODIMENTS

Broadly speaking, embodiments of the present invention provide a polymorphic stacked DRAM architecture, circuit, system, and method of operation wherein the stacked DRAM may be dynamically configured to operate part of the stacked DRAM as memory and part of the stacked DRAM as cache. The memory portion of the stacked DRAM is specified with reference to a predetermined region of the physical address space so that data accesses to and from the memory portion corresponds to merely reading or writing to those locations. The cache portion of the stacked DRAM is specified with reference to a Finite State Machine (FSM) which checks the address tags to identify if the required data is in the cache portion and enables reads/writes based on that information. With the disclosed polymorphic stacked DRAM, the partition sizes between the memory and cache portions may vary dynamically based on application requirements. By optimally splitting the stacked DRAM between memory and cache portions so that the sizes can vary over time, the memory portion provides the advantage of faster access time (as compared to cache accesses which require additional processing time and resources associated with tag matching), while the cache portion has greater flexibility in adapting to application phase changes (as compared to memory accesses which require OS-enabled data remapping of off-chip DRAM to specific physical addresses along with cache flushes and translation lookaside buffer (TLB) shootdowns to enable the remapping) and less overhead of wasted space (due to the smaller granularity of the cache). Initially configured entirely as a cache, the stacked DRAM is partitioned by the OS over runtime into memory and cache regions, depending on the data access patterns. The partition may be controlled using an On-chip Memory Size Register (OMSR) which maintains the bounding physical address (start address+MEMSIZE) in which the memory region falls. When a memory request address falls within the region identified by the OMSR, the memory request is processed as a request to the memory portion of the stacked DRAM. Otherwise, the memory request is processed by the FSM as a request to the cache portion of the stacked DRAM.

In selected example embodiments, a stacked processor device and fabrication methodology are provided for forming a plurality of chips into a multi-chip stack which includes a polymorphic stacked memory. In selected embodiments, the stacked processor device includes a processor chip as a first layer, where the processor chip may be formed as a central-processing-unit (CPU), a graphics-processing-unit (GPU), a baseband, a digital-signal-processing (DSP), a wireless local area network (WLAN), a multi-core CPU, a multi-core graphical processing unit GPU, or a hybrid CPU/GPU system. The stacked processor device also includes a stacked polymorphic memory chip (e.g., one or more stacked DRAM chips) as a second layer that is connected to the processor chip through a plurality of through-silicon-via structures, where the memory chip includes a memory with an adjustable memory portion and an adjustable cache portion such that memory can operate simultaneously in both memory and cache modes. In selected embodiments, the stacked polymorphic memory chip includes an on-chip memory size register for storing a bounding physical address for the memory portion; a comparator for comparing an incoming memory access request to the bounding physical address stored in the on-chip memory size register; a cache finite state machine module connected to process the incoming memory access request as a cache access request if the comparator determines that the incoming memory access request is not a memory request; a memory controller connected to both the comparator and the cache finite state machine module and configured to access the adjustable memory portion if the comparator determines that the incoming memory access request falls within the bounding physical address stored in the on-chip memory size register, but to otherwise access the adjustable cache portion; and a direct memory access engine connected to the cache finite state machine module and the memory controller for enabling data movement between the memory on the stacked polymorphic memory chip and an off-chip memory system. In operation, the memory in the stacked polymorphic memory chip is initialized to operate in a cache mode so that the entirety of the memory initially serves as the cache portion, but is also configured to operate in both memory and cache modes by increasing the memory portion and decreasing the cache portion in response to application or operating system requirements. For example, the memory in the stacked polymorphic memory chip may be configured to move one or more cache lines from the cache portion to the memory portion if a number of accesses to a page in the cache portion containing the one or more cache lines reaches a threshold number of accesses, thereby readjusting the size of the adjustable memory portion and the adjustable cache portion.

In other embodiments, there is provided a multi-layer die stack and method of manufacturing same. The multi-layer die stack includes a processor die layer that is operable to perform data processing for the multi-layer die stack, and may be implemented as a central-processing-unit (CPU), a graphics-processing-unit (GPU), a baseband circuit module, a digital-signal-processing (DSP), a wireless local area network (WLAN) circuit module, a multi-core CPU, a multi-core graphical processing unit GPU, or a hybrid CPU/GPU system. The multi-layer die stack also includes a stacked memory die layer that is operable to store data in a polymorphic stacked dynamic random access memory (DRAM) which may be configured to operate in whole or in part as a memory or cache so that the polymorphic DRAM can operate simultaneously in both memory and cache modes. In operation, the polymorphic DRAM may be initialized to operate in a cache mode so that the entirety of the polymorphic DRAM initially serves as a cache portion, and during subsequent operations, the polymorphic DRAM is configured to increase a memory portion and decrease the cache portion in response to application or operating system requirements. In selected embodiments, the stacked memory die layer may be implemented with one or more stacked DRAM memory chips connected to the processor die layer through a plurality of through-silicon-via structures. In other embodiments, the stacked memory die layer includes a memory with an adjustable memory portion and an adjustable cache portion; a memory size register for storing a bounding physical address for the memory portion; a comparator for comparing an incoming memory access request to the bounding physical address stored in the memory size register; a cache finite state machine module connected to process the incoming memory access request as a cache access request if the comparator determines that the incoming memory access request is not a memory request; and a memory controller connected to both the comparator and the cache finite state machine module and configured to access the adjustable memory portion if the comparator determines that the incoming memory access request falls within the bounding physical address stored in the memory size register, but to otherwise access the adjustable cache portion. The stacked memory die layer may also include a direct memory access engine for enabling data movement between the polymorphic DRAM and an off-chip memory system. As will be appreciated, the disclosed multi-layer die stack may be implemented in a variety of different applications, including but not limited to a computer, a mobile phone, a mobile compu-phone, a camera, an electronic book, a digital picture frame, an automobile electronic product, a 3D video display, a 3D television, a 3D video game player, a projector, or a server used for cloud computing.

In yet other embodiments, a method is disclosed for operating a stacked memory in both cache and memory modes. In operation, the stacked memory is initialized in a cache mode so that an adjustable first portion of the stacked memory operates as a cache. Subsequently, an adjustable second portion of the stacked memory is allocated to operate in a memory mode upon receiving a partition instruction by specifying a physical address space in the stacked memory to be used for the adjustable second portion of the stacked memory. In selected embodiments, the physical address space in the stacked memory is specified by storing a bounding physical address for the adjustable second portion of the stacked memory in an on-chip memory size register. When an access request and associated access address is received at the stacked memory, an adjustable second portion of the stacked memory is accessed if the access address falls within the physical address space, but otherwise the adjustable first portion of the stacked memory is accessed if the access address does not fall within the physical address space. Upon receiving an update partition instruction, the adjustable first and second portions of the stacked memory are reallocated so that the adjustable first portion of the stacked memory increases or decreases in size to adjust the size of the first portion of the stacked memory operating in cache mode relative to the size of the second portion of the stacked memory operating in memory mode. In addition, the number of accesses to a specific page in the adjustable first portion of the stacked memory may be counted to determine when a threshold count is reached for the specific page, at which point any cache lines belonging to the specific page may be transferred from the adjustable first portion of the stacked memory to the adjustable second portion of the stacked memory by reallocating the adjustable first and second portions of the stacked memory so that the adjustable first portion of the stacked memory decreases in size and the adjustable second portion of the stacked memory increases in size.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates in simplified block diagram form an example system architecture of a multi-layer die stack including at least a last level stacked memory and processor element;

FIG. 2 illustrates in simplified block diagram form an example polymorphic DRAM array cache and memory portions separated by a dynamically adjustable partition;

FIG. 3 illustrates how data fetch operations are performed in the cache portion of the stacked memory; and

FIG. 4 illustrates a flow diagram for the operation of a stacked DRAM memory in accordance with selected embodiments of the present invention.

### DETAILED DESCRIPTION

A polymorphic stacked memory architecture, design, and method of operation are described wherein the stacked memory is configured to allow both cache and memory accesses to different portions of the stacked memory which may be dynamically partitioned to provide a cache portion for fast cache operations and a memory portion for mapping application data that can be quickly accessed. By combining cache and memory operations in a single, dynamically partitioned stacked memory, the low latency benefits of fast access to memory are obtained along with the benefits of cache access, such as increased flexibility in adapting to application phase changes and lower overhead of wasted space. The stacked memory architecture may be implemented by stacking RAM memory (e.g., DRAM and/or SRAM) on top of a processing element (e.g., a multi-core processor) to provide both memory and cache storage areas in a dynamically partitioned memory portion and cache portion. The memory portion corresponds to a specific region of the physical address space and accessing data from this portion corresponds to merely reading or writing to those locations. The cache portion has a Finite State Machine (FSM) to check the address tags to identify if the required data is in cache and enabling reads/writes based on that information. By optimally splitting the stacked memory between the memory and cache portions so that their sizes can vary over time, the polymorphic stacked memory exploits the benefits of both memory and cache operations without incurring the performance limitations.

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. Some portions of the detailed descriptions provided herein are presented in terms of algorithms and instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities. Unless specifically stated otherwise as apparent from the following discussion, it is appreciated that, throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

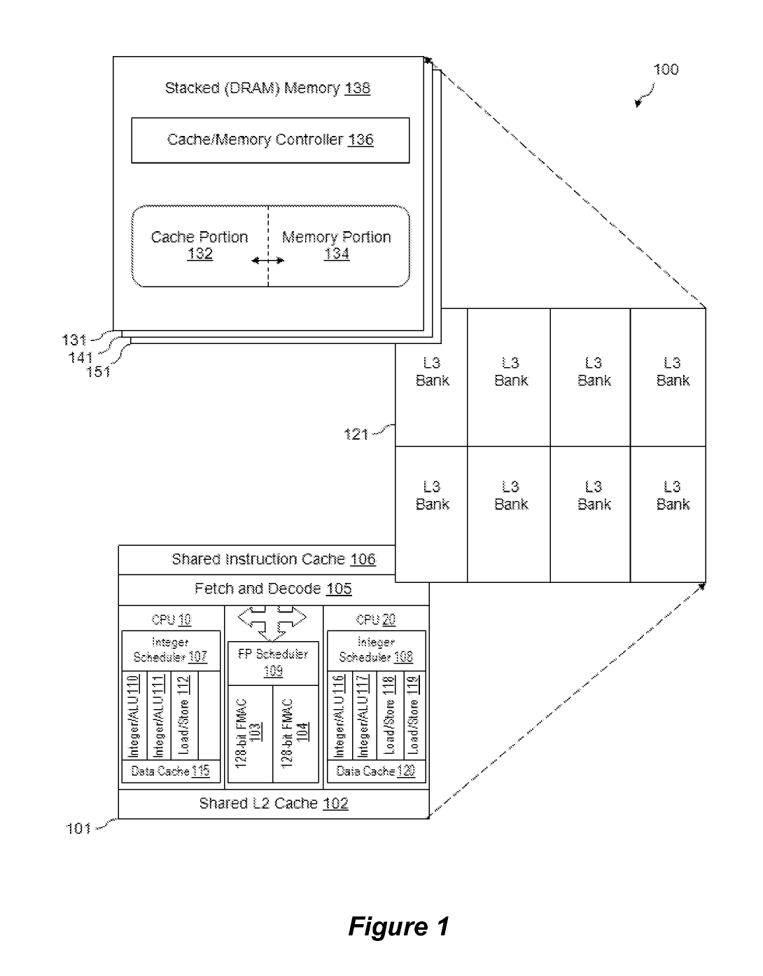

Referring now to FIG. 1, there is shown in simplified block diagram form an example system architecture 100 of a three-layer die stack including a processor element 101, a level-3 (L3) cache layer 121, and a stacked memory 138. The bottom die in this example may be implemented with any desired processor element 101, including but not limited to Advanced Micro Device's Bulldozer CPU or Bobcat CPU die. For example, the processor element 101 may be implemented as a monolithic dual-CPU building block including a first CPU 10 and second CPU 20, though other multi-core or single core processor elements can be used. Each CPU (e.g., 10) has its own integer scheduler 107, integer ALUs 110, 111, load store units 112, 113, data cache 115, program counter, and registers. To software, the CPUs 10, 20 appear to be entirely independent, executing two different instruction streams or threads. But in hardware, an instruction fetch and decode unit 105, floating point unit 109 with fused multiply-accumulate units 103, 104, instruction cache 106, and level-two (L2) cache are shared between the two threads. Though the L3 cache layer 121 may be implemented as a separate die layer composed of 8 L3 banks that are connected with through-silicon via technology to the shared L2 cache 102 through a crossbar, it will be appreciated that the L3 cache may instead be implemented in the processor element die 101, or alternatively as the stacked memory 138. As described more fully below, the stacked memory 138 may be formed with one or more stacked DRAM memory die 131, 141, 151 which implement stacked memory 138 having a cache/memory controller 136 for dynamically controlling the operation and partitioning of the memory 130 to simultaneously operate a cache portion 132 and a memory portion 134. For the 3D connections, the one or more stacked DRAM memory die 131, 141, 151 may be connected to the L3 cache layer 121 (and/or processor element 101) using through-silicon via technology. Though not shown, an off-chip main memory subsystem composed of one or more channels may connected to the three-layer die stack 101, 121, 138.

Generally speaking, there are many performance advantages associated with memory access operations which involve a direct access to a specific memory location to fetch the data. And while cache access operations are typically faster than accessing off-chip memory, a cache access operation is typically slower than an on-chip memory access at the same level because of the processing requirements for performing tag match operations before fetching the data. There is also additional processing overhead associated with cache access operations, such as maintaining tags for each cache entry and other cache coherency processing requirements, which can become a significant performance-killer due to their space requirements. In addition, cache line replacements hardware can become complicated for large caches with small line sizes. These advantages might suggest that the entirety of the stacked memory 138 should be used for direct memory access operations, and not as a cache. However, there are certain costs associated with memory access operations. For example, when software is used to maintain memory, data that needs to be moved from off-chip DRAM must be mapped to specific physical addresses, and this requires cache flushes and TLB shootdowns to enable the remapping. There are also delays associated with waiting for the operation system (OS) to enable remapping for direct memory operations, in contrast to cache operations which maintain data in hardware. As a consequence, the stacked memory die 138 would have limited flexibility and reduced performance in adapting to application phase changes if the entirety of the stacked memory 138 were used for direct memory access operations. There are also efficiency considerations in avoiding wasted space since memory typically operates with a larger page granularity (e.g., 4 KB) as compared to the smaller cache line granularity (e.g., 64/128B line size). Beyond these considerations, remapping operations for memory access operations can require OS and/or application modifications to utilize the high speed memory efficiently. As a result, there are sub-optimalities associated with using the stacked memory 138 only as a memory or only as a cache.

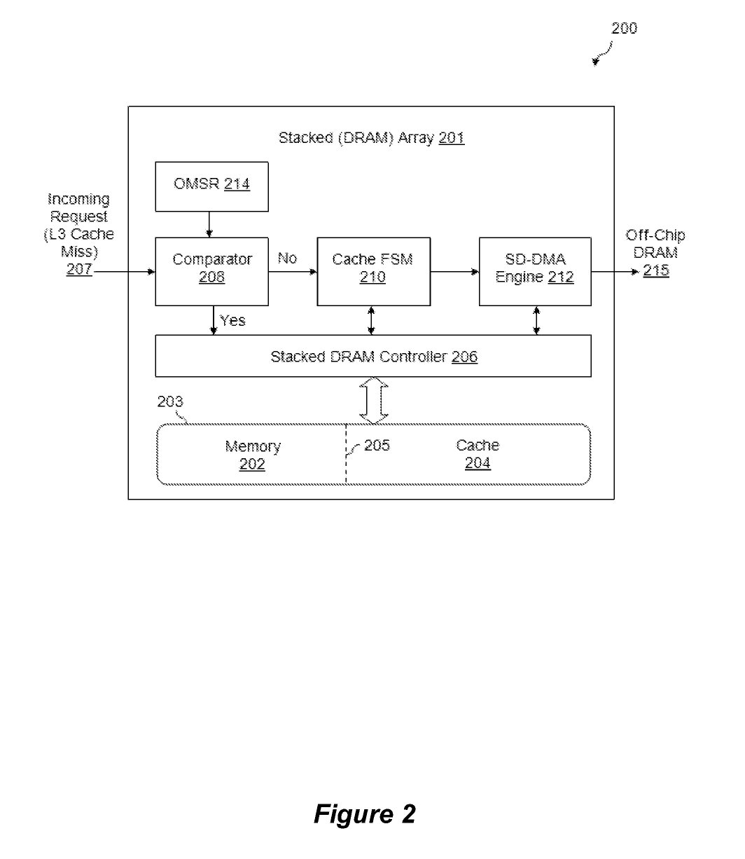

To optimize the use of both direct memory and cache memory operations, there is disclosed with reference to FIG. 2 an example polymorphic stacked DRAM device 200 which is implemented with one or more die layers 201. The polymorphic stacked DRAM device 200 includes a DRAM memory 203 which may be configured to simultaneously operate a part of the DRAM memory 203 as memory 202 and the rest as cache 204, where the memory 202 and cache 204 portions are separated by a dynamically adjustable partition 205. In operation, the memory portion 202 corresponds to a specific region of the physical address space in the DRAM memory 203 so that data accesses to the memory portion 202 correspond to merely reading or writing to those locations. For the cache portion 204, a Finite State Machine (FSM) 210 is provided to check the address tags to identify if the required data is in the cache portion 204 and to enable read/write operations based on that information. The partition 205 separating the memory 202 and cache 204 portions is effectively controlled by the On-chip Memory Size Register (OMSR) 214 and can be varied dynamically based on the application requirement. By optimally splitting the stacked DRAM 203 between the memory 202 and cache 204 portions and enabling their sizes to vary over time, the performance benefits of the memory and cache operations can be optimized.

In operation, the polymorphic stacked DRAM device 200 is initialized in a cache mode so that the entire DRAM memory 203 begins its operation as a cache. Depending on the data access pattern, the OS configures the polymorphic stacked DRAM device 200 to split the DRAM memory 203 over runtime into the memory 202 and cache 204 regions. The partition 205 is controlled using an On-chip Memory Size Register (OMSR) 214 which maintains the bounding physical address (start address+MEMSIZE) in which the memory region 202 falls. To allow for application requirements where the entirety of the DRAM memory 203 is used as memory, the BIOS maps the OMSR 214 to a predetermined region of the physical address space.

When an incoming request 207 (such as an L3 cache miss) is received at the stacked DRAM device 200, it must be identified as either a cache or memory request. To this end, the request 207 is filtered by comparing the incoming address against the OMSR 214 at comparator 208. If the incoming address falls within the memory region identified by the OMSR 214, the request 207 is processed by the stacked DRAM controller 206 as a simple request to the memory location 202. On the other hand, if the incoming request 207 does not fall within the memory region identified by the OMSR 214, the request 207 is processed as a cache access by the cache FSM 210 to access the cache portion 204 through the stacked DRAM controller 206.

The memory portion 202 of the DRAM memory 203 can be used to store not only pages from off-chip memory, but also one or more cache lines corresponding to a particular page that are transferred from the cache portion 204. By migrating cache lines from the cache portion 204 into the memory portion 202, faster access is enabled by avoiding tag comparisons that are required for a cache access so that the OMSR 214 comparison technique provides enormous performance benefits for retrieving frequently accessed data from the memory portion 202. An additional benefit of using the memory portion 202 is the space savings obtained from removing the data tag storage space requirements from the cache. In selected embodiments, the page size for the memory portion 202 may be the same (e.g., 4 KB) as the off-chip DRAM memory to avoid the additional hardware cost associated with modifying the TLB.

The stacked-DRAM Direct Memory Access (SD-DMA) engine 212 is provided to enable data movement between the on-chip stacked DRAM 203 and off-chip memory. However, the SD-DMA 212 is configured to be flexible in terms of adapting to the requirements of servicing the cache 204 or the memory 202 portions since there are different data transfer granularities for the cache 204 (e.g., 512B) or the memory 202 (e.g., 4 KB) portions. In addition, the SD-DMA 212 must accommodate the different coherency requirements. For example, to evict an entry from cache portion 204, the SD-DMA 212 must flush data from caches higher up in the hierarchy. Conversely for memory, page replacement leads to a TLB shootdown.

The cache portion 204 of the DRAM memory 203 may be used as a last-level inclusive cache in the memory hierarchy looking at the traffic to and from the L3 cache 121 (or whatever the next-to-last cache level is). In an example implementation, the cache portion 204 may be implemented as a 32-way associative cache with line sizes of 512B, though other cache line sizes and associativity can be used, depending on the desired performance tradeoffs. While any desired approach may be used to store and access tag and data from the cache portion 204, in selected embodiments, both the tags and data may be placed in the cache portion 204 and accessed in serial order. This allows the tags corresponding to a set to be placed in a single DRAM page so that the tag can be accessed in one single read operation. As a result, a hit on the DRAM cache portion 204 would involve only two fetches, one to fetch the tags and the other to fetch the data if the tag match succeeds. Otherwise, multiple accesses would be required, depending on where the tag location and additional meta-data is stored.

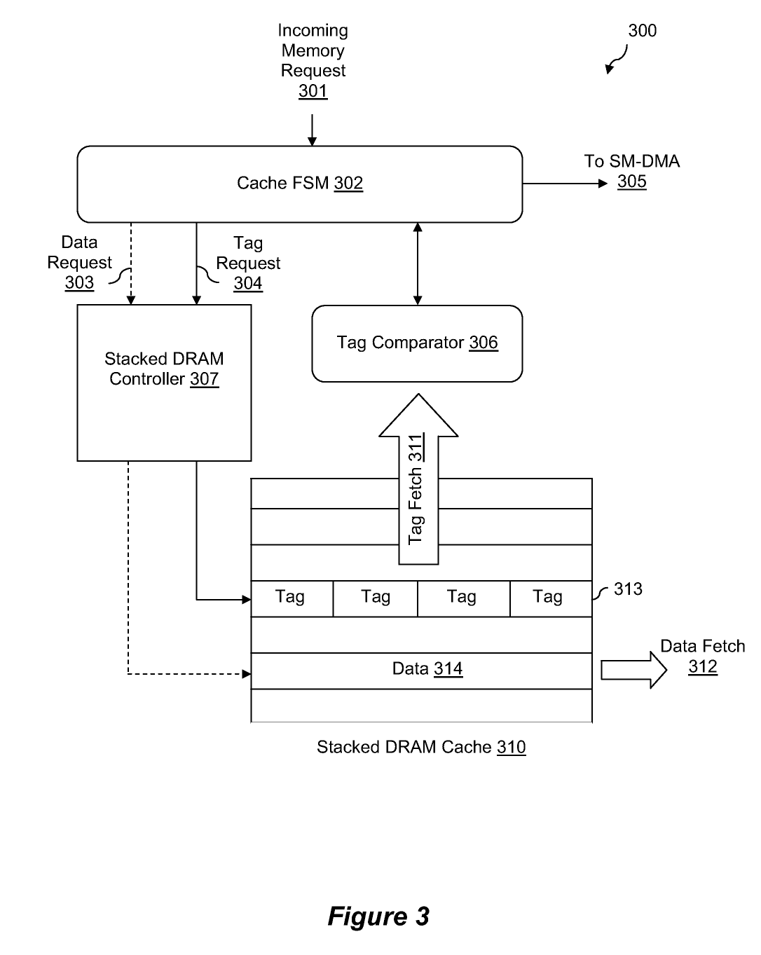

To illustrated selected embodiments wherein data is fetched from the cache portion of the polymorphic stacked DRAM device, reference is now made to FIG. 3 which illustrates the signal flow design 300 for data fetch operations in the cache portion of the stacked memory. In the depicted design, the stacked DRAM cache 310 represents the cache portion of the DRAM memory, where each entry in the stacked DRAM cached 310 corresponds to a DRAM page (4 KB). An incoming memory request 301 which has been determined to be a cache memory request (e.g., from the OMSR comparison operation) is received at the cache FSM 302. In a first fetch operation, the FSM 302 issues a tag request 304 to the stacked DRAM controller 307 to access the stored tags 313 in the cache portion 310 and return the fetched tag 311 for comparison at the tag comparator 306. If there is no comparison match, the incoming memory request is forwarded to the SD-DMA 305. However, if there is comparison match, the cache FSM 302 sends a data request 303 through the stacked DRAM controller 307 to fetch the associated data 314 from the stacked DRAM cache 310 for output 312.

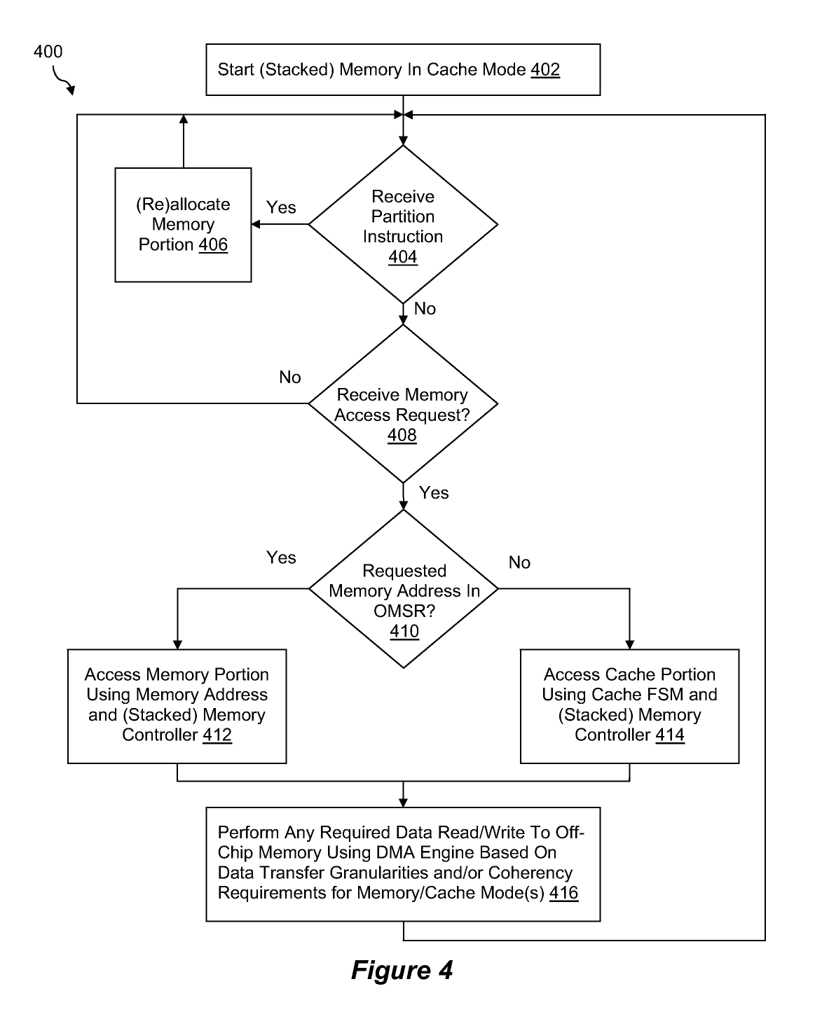

Turning now to FIG. 4, there is illustrated a flow diagram 400 for the operation of a memory, such as a stacked DRAM memory, in accordance with selected embodiments of the present invention. The method begins at step 402 during an initiation phase where the memory is started in a cache mode such that the entirety of the memory is configured to operate as cache memory. For purposes of explaining the memory operation, the memory may be a stacked DRAM memory, but the principles of operations will work with other unstacked memories, as well as non-DRAM types of memory or even combinations of DRAM memory with non-DRAM memory.

At step 404, the process checks to see if a partition instruction is received. As described herein, a partition instruction effectively controls the allocation and size of the cache and memory portions of the memory, and can be dynamically adjusted to adjust the size of the cache/memory allocation during runtime. In selected embodiments, the operating system (OS) manages a process for issuing partition instructions, depending upon application requirements or other factors. For example, the initialized memory may store data at random locations of the cache portion of memory based on the application requirements and any desired cache policy. But depending on the cache activity, one or more pages from the cache portion may be moved to the memory portion, at which point the cache/memory partition must be adjusted. The partition control may be implemented at the OS by using performance counters to track which page(s) contains frequently-used cache lines so that any page having frequently accessed cache lines is moved by the OS into the memory portion and the associated cache lines are removed from the cache portion. Of course, the movement of a page from the cache portion to the memory portion may require adjustment of the partitioning of the cache/memory allocation, such as by issuing a new partition instruction to reflect the new cache/memory allocation. Thus, when a partition instruction is received which changes the cache/memory allocation (affirmative outcome to decision 404), the memory allocation is changed (step 406), such as by updating the value stored in the On-chip Memory Size Register which maintains the bounding physical address (start address+MEMSIZE) for the memory portion.

As will be appreciated, any change in the size of the cache portion may require that the cache lines be flushed to memory since the indexing scheme for accessing cache lines changes if the number of cache sets increases. Also, certain regions of the memory portion may need to be paged out when increasing the size of the cache portion. Another approach for dealing with cache reallocation that would require less overhead would be to vary the associativity of cache. While changing the cache associativity would not require that cache lines be flushed since the indexing does not change, this solution comes with an increased space requirement for the tags since offsets within a page can belong to different sets. Regardless of how the cache/memory reallocation is achieved, the stacked DRAM controller can prevent memory access conflicts by locking the bus during the reallocation procedure.

In the memory portion, it will be appreciated that a TLB shootdown is required whenever there is change in the virtual-to-physical address mapping. To avoid the need for flushing the entire TLBs in the different cores, the memory allocation procedure (step 406) may be optimized by exploiting the fact TLBs in current-day processors are equipped with tags that correspond to the address space identifiers (ASIDs) so that the ASIDs can be used to flush only specific entries based on the application for which the remapping occurs. Hardware-managed TLBs can also be used as they are much faster at handling misses and shootdowns. In any event, these solutions can be combined with a lazy devaluation of the TLB entries in which the TLB entries are invalidated only when absolutely required.

Returning now to FIG. 4, the operation of the memory proceeds in the absence of a (new) partition instruction (negative outcome to decision 404) to monitor the bus for memory access requests. If no request is received (negative outcome to decision 406), the process waits until the next partition instruction or memory access request is received. However, upon receiving a memory access request (affirmative outcome to decision 406), the request is identified as either a cache or memory request (step 410). In selected embodiments, the identification process entails simply comparing the memory address from the memory access request against the value stored in the OMSR. If the memory address falls within the memory region identified by the OMSR (affirmative outcome to decision 410), then the memory portion is accessed using the memory controller to access the memory address from the memory portion (step 412). On the other hand, if the memory address does not fall within the memory region identified by the OMSR (negative outcome to decision 410), then the cache FSM and memory controller are used to access the cache portion if the memory address is stored (step 414).

At step 416, any required off-chip data read/write operations are performed using the direct memory access (DMA) engine which enables data movement between the on-chip stacked DRAM memory and off-chip memory. While the basic requirements remain the same as a conventional off-chip memory-to-disk DMA engine, the DMA engine is configured to be flexible in terms of adapting to the requirements of servicing the cache or the memory regions. The need arises from the difference in the data transfer granularities for the cache and memory portion, 512B for caches and 4 KB for memory. The coherency requirements differ as well, evicting an entry from cache requiring flushing data from caches higher up in the hierarchy. For memory though, page replacement leads to a TLB shootdown.

As described herein, the polymorphic stacked DRAM may be configured to operate in two different modes, thereby obtaining enhanced application performance by exploiting two different granularities of locality inherent in data access patterns, namely “within-a-page” accesses (using the memory mode/portion) and patterns that access specific data “across-pages” (using the cache mode/portion). Thus, the memory mode enables faster access to data by avoiding the tag comparison and fetch processes, but the granularity of operating at a page-level in memory mode can be very costly, especially when applications accesses are random. With the disclosed polymorph stacked DRAM, the use of memory and cache portions can be balanced by moving cache lines in a page from the cache portion to the memory portion whenever the number of accesses to the specific page increases beyond a threshold in the cache partition. The migration from cache to memory portions improves performance by eliminating the processing overhead of tag checking for frequently accessed data and also avoiding the linear access to tags and then data. In addition, the selective migration of only frequently accessed cache lines ensures that random data accesses continue to be serviced from the cache portion. In this way, the cache and memory portions operate together to satisfy different granularities of data locality, thereby significantly improving performance. An example application of using the balanced performance of the cache and memory portions would be an enterprise software application in which a database and search engine functionality are used which incorporate large indexing structures. When the indexing structures are read frequently, they can be mapped to the memory portion of the stacked DRAM. On the other hand, the data held by the indexing structures can be at random locations, and therefore is advantageously mapped to the cache portion of the stacked DRAM.

Although the described exemplary embodiments disclosed herein are directed to selected stacked DRAM embodiments and methods for operating same, the present invention is not necessarily limited to the example embodiments which illustrate inventive aspects of the present invention that are applicable to a wide variety of memory types, processes and/or designs. Thus, the particular embodiments disclosed above are illustrative only and should not be taken as limitations upon the present invention, as the invention may be modified and practiced in different but equivalent manners apparent to those skilled in the art having the benefit of the teachings herein. For example, the stacked memory may by formed with DRAM or SRAM memories or any combination thereof. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

Accordingly, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A stacked processor device, comprising:
a processor chip; and
a stacked memory chip connected to the processor chip and comprising a memory with an adjustable memory portion and an adjustable cache portion such that the memory can operate simultaneously in both memory and cache modes.

2. The stacked processor device of claim 1, where the processor chip comprises a central-processing-unit (CPU), a graphics-processing-unit (GPU), a baseband circuit module, a digital-signal-processing (DSP) circuit, a wireless local area network (WLAN) circuit module, a multi-core CPU, a multi-core GPU, or a hybrid CPU/GPU system.

3. The stacked processor device of claim 1, where the stacked memory chip comprises one or more stacked dynamic random access memory chips.

4. The stacked processor device of claim 1, where the stacked memory chip comprises:
an on-chip memory size register for storing a bounding physical address for the memory portion;
a comparator for comparing an incoming memory access request to the bounding physical address stored in the on-chip memory size register;
a cache finite state machine module connected to process the incoming memory access request as a cache access request responsive to a determination that the incoming memory access request is not a memory request; and
a memory controller connected to both the comparator and the cache finite state machine module and configured to access the adjustable memory portion responsive to a determination that the incoming memory access request falls within the bounding physical address stored in the on-chip memory size register, but to otherwise access the adjustable cache portion.

5. The stacked processor device of claim 4, where the stacked memory chip further comprises a direct memory access engine connected to the cache finite state machine module and the memory controller for enabling data movement between the memory on the stacked memory chip and an off-chip memory system.

6. The stacked processor device of claim 1, where the memory in the stacked memory chip is initialized to operate in a cache mode during initialization of the stacked processor device so that the entirety of the memory initially serves as the cache portion.

7. The stacked processor device of claim 6, where the memory in the stacked memory chip is configured to operate in both memory and cache modes by increasing the memory portion and decreasing the cache portion in response to application or operating system requirements.

8. The stacked processor device of claim 1, where the memory in the stacked memory chip is configured to move one or more cache lines from the cache portion to the memory portion if a number of accesses to a page in the cache portion containing the one or more cache lines reaches a threshold number of accesses, thereby readjusting the size of the adjustable memory portion and the adjustable cache portion.

9. A multi-layer die stack comprising:
a processor die layer operable to perform data processing for the multi-layer die stack; and
a stacked memory die layer operable to store data in a polymorphic stacked dynamic random access memory (DRAM) which may be configured to operate in whole or in part as a memory or cache so that the polymorphic stacked DRAM can operate simultaneously in both memory and cache modes.

10. The multi-layer die stack of claim 9, where the multi-layer die stack is implemented in a computer, a mobile phone, a mobile compu-phone, a camera, an electronic book, a digital picture frame, an automobile electronic product, a 3D video display, a 3D television, a 3D video game player, a projector, or a server used for cloud computing.

11. The multi-layer die stack of claim 9, where the processor die layer comprises a central-processing-unit (CPU), a graphics-processing-unit (GPU), a baseband circuit module, a digital-signal-processing (DSP) circuit, a wireless local area network (WLAN) circuit module, a multi-core CPU, a multi-core GPU, or a hybrid CPU/GPU system.

12. The multi-layer die stack of claim 9, where the stacked memory die layer comprises one or more stacked DRAM memory chips connected to the processor die layer through a plurality of through-silicon-via structures.

13. The multi-layer die stack of claim 9, where the stacked memory die layer comprises:
a memory with an adjustable memory portion and an adjustable cache portion;
a memory size register for storing a bounding physical address for the memory portion;
a comparator for comparing an incoming memory access request to the bounding physical address stored in the memory size register;
a cache finite state machine module connected to process the incoming memory access request as a cache access request responsive to a determination that the incoming memory access request is not a memory request; and
a memory controller connected to both the comparator and the cache finite state machine module and configured to access the adjustable memory portion responsive to a determination that the incoming memory access request falls within the bounding physical address stored in the memory size register, but to otherwise access the adjustable cache portion.

14. The multi-layer die stack of claim 9, where the stacked memory die layer further comprises a direct memory access engine for enabling data movement between the polymorphic stacked DRAM and an off-chip memory system.

15. The multi-layer die stack of claim 9, where the polymorphic stacked DRAM is initialized to operate in a cache mode following start-up so that the entirety of the polymorphic stacked DRAM initially serves as a cache portion.

16. The multi-layer die stack of claim 15, where the polymorphic stacked DRAM is configured to operate in both memory and cache modes by increasing a memory portion and decreasing the cache portion in response to application or operating system requirements.

17. A method comprising:
initializing a stacked memory in a cache mode so that an adjustable first portion of the stacked memory operates as a cache; and
allocating an adjustable second portion of the stacked memory to operate in a memory mode upon receiving a partition instruction by specifying a physical address space in the stacked memory to be used for the adjustable second portion of the stacked memory.

18. The method of claim 17, further comprising:
receiving an update partition instruction to reallocate the adjustable first and second portions of the stacked memory so that the adjustable first portion of the stacked memory increases or decreases in size to adjust the size of the first portion of the stacked memory operating in cache mode relative to the size of the second portion of the stacked memory operating in memory mode.

19. The method of claim 17, where specifying the physical address space in the stacked memory comprises storing a bounding physical address for the adjustable second portion of the stacked memory in an on-chip memory size register.

20. The method of claim 17, further comprising:
counting the number of accesses to a specific page in the adjustable first portion of the stacked memory to determine when a threshold count is reached for the specific page; and
when the threshold count is reached for the specific page, transferring any cache lines belonging to the specific page from the adjustable first portion of the stacked memory to the adjustable second portion of the stacked memory by reallocating the adjustable first and second portions of the stacked memory so that the adjustable first portion of the stacked memory decreases in size and the adjustable second portion of the stacked memory increases in size.

21. The method of claim 17, further comprising:
receiving at the stacked memory an access request comprising an access address; and
accessing the adjustable second portion of the stacked memory if the access address falls within the physical address space, but otherwise accessing the adjustable first portion of the stacked memory if the access address does not fall within the physical address space.
